(19) United States
(12) Patent Application Publication
(10) Pub. No.: US 2023/0302364 A1
(43) Pub. Date: Sep. 28, 2023

(54) METHOD AND APPARATUS FOR IDENTIFYING, CERTIFYING, AND AUTHENTICATING A GAME EVENT ITEM AS NFT MEMORABILIA

(71) Applicant: Gol-Ball Inc., Miami, FL (US)

(72) Inventor: Andres Rodriguez, Miami, FL (US)

(21) Appl. No.: 18/151,135

(22) Filed: Jan. 6, 2023

Related U.S. Application Data
(60) Provisional application No. 63/423,437, filed on Nov. 7, 2022.
(60) Provisional application No. 63/353,386, filed on Jun. 17, 2022.
(60) Provisional application No. 63/362,673, filed on Apr. 8, 2022.
(60) Provisional application No. 63/362,563, filed on Apr. 6, 2022.
(60) Provisional application No. 63/269,729, filed on Mar. 22, 2022.

(30) Foreign Application Priority Data
Aug. 11, 2022 (EP) 22190050.9

(51) Int. Cl. A63F 13/73; A63F 13/812

(52) U.S. Cl. CPC A63F 13/73; A63F 13/812

(57) ABSTRACT

A system and methods for identifying and certifying a game item in a sports game is disclosed. The method including storing a plurality of unique identifiers corresponding to a plurality of game items, each unique identifier corresponding to a unique game item in the plurality of game items, generating a record for each of the plurality of unique identifiers, determining a game event and the involvement of at least one event item, receiving a message indicating the game event, the message comprising the unique identifier of the event item, identifying the event item based at least in part on the unique identifier of the event item, and updating the record of the event item to indicate that the event item is the game item involved in the game event.

### RELATED APPLICATION DATA

This application claims priority to U.S. Provisional Application No. 63/423,437 filed Nov. 7, 2022, European Patent Application No. 22190050.9 filed Aug. 11, 2022, U.S. Provisional Application No. 63/353,386 filed Jun. 17, 2022, U.S. Provisional Application No. 63/362,673 filed Apr. 8, 2022, U.S. Provisional Application No. 63/362,563 filed Apr. 6, 2022, and U.S. Provisional Application No. 63/269,729 filed Mar. 22, 2022, the disclosures of which are hereby incorporated by reference in their entirety.

### FIELD

The present invention relates to a method, an apparatus, and a computer-readable medium for identifying, certifying, and authenticating an item involved in an event in a sports game and the same as non-fungible token (NFT) memorabilia.

### BACKGROUND

Sports games produce memorable moments. Items involved in those memorable moments may later become highly-sought collectibles. For example, a soccer ball used to score a goal, a jersey worn by a famous player achieving a record-breaking milestone, or a baseball bat used to hit a championship winning homerun. Surprisingly, there is no current category in sports memorabilia that uniquely identifies a game item involved in significant game events. There is no reliable way of identifying and authenticating an item that was involved in a significant game event, thereby leading to uncertainty in the memorabilia market and a lack of certified historical items.

A challenge with identifying, certifying, and authenticating a game item is that the game item involved in a significant game event is often not removed from the field of play until the entire game is over. In many instances, there are multiple identical game items in one game (e.g., multiple balls, baseball bats, etc.) Often, these game items may be reused or substituted in the game, making it virtually impossible to be identified as the specific item involved in a specific event in the game, because they are constantly being interchanged with other identical items throughout the game.

Presently, there are no systems in any sports in the world to uniquely identify a game item. This inability to uniquely identify a game item leads to uncertainty in any potential claim being made regarding the authenticity of the item after a match. Even if someone consciously removed an item from a game after a significant event, there is no system to guarantee that a given item was involved in the event during the match. As a result, it is difficult for owners of authentic items to prove their authenticity, thereby impeding transferability of the memorabilia.

Technology does exist that attempts to authenticate game items that are involved in memorable moments. For example, tamperproof tags have been developed that can be used to authenticate a game ball or other important item relating to such a memorable moment. But, forgery using advanced printers and other devices has become more commonplace, making such tags less reliable. Painting or otherwise permanently marking game items is also possible but, again, can be forged or can wear off over time. Certificates of authenticity can also be forged or lost. Each of these systems for authenticating game items has drawbacks, in part due to the relatively private nature of the system used for authentication.

Accordingly, improvements are needed in systems for identifying, certifying, and authenticating a game item involved in a game event as memorabilia.

This disclosure provides a novel method, apparatus, and computer-readable medium for identifying, certifying, and authenticating a game item involved in a game event and subsequent minting of NFT off the item.

### BRIEF DESCRIPTION OF THE DRAWINGS

FIG. 1 illustrates a flowchart for identifying an event item according to an exemplary embodiment.

FIG. 2 illustrates an example of a correspondence between unique identifiers and game items according to an exemplary embodiment.

FIG. 3 illustrates an example of a game item with a physical representation of a unique identifier according to an exemplary embodiment.

FIGS. 4A-4B illustrate examples of a game item with physical representations of unique identifiers according to an exemplary embodiment.

FIG. 5A-5B illustrates examples of a game event message sending and receiving process according to exemplary embodiments.

FIG. 6 illustrates an example of an event item identification process and a game event record generation process according to an exemplary embodiment.

FIG. 7 illustrates an example of receiving game event data and authenticity data according to an exemplary embodiment.

FIG. 8 illustrates a flowchart for linking the event item to an NFT and transferring ownership of the NFT according to an exemplary embodiment.

FIG. 9 illustrates a flowchart for linking the event item to a plurality of duplicate NFTs and transferring ownership of the duplicate NFTs according to an exemplary embodiment.

FIG. 10 illustrates a flowchart for granting users access to a three-dimensional model of an event item according to an exemplary embodiment.

FIG. 11 illustrates a system diagram of the game item database/server, the corresponding NFTs, and corresponding user access rights according to an exemplary embodiment.

FIG. 12 illustrates a method for retrieving a game event record according to an exemplary embodiment.

FIG. 13 illustrates an example of a game event record linked to the game event unique identifier according to an exemplary embodiment.

FIG. 14 illustrates an example of a system that can be used to implement the above-described processes according to an exemplary embodiment.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations, and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

While some exemplary embodiments in the present disclosure focus on goal scoring in soccer games, which is one of the most important game events in a soccer game, game events may include other events where a goal is not scored. For example, Roberto Baggio missed a penalty in the penalty shoot-out of the 1994 World Cup final. His disappointment became a classic image of the World Cup and Baggio himself. The game ball in use may nevertheless have value in the collectible market and could be identified, certified, and authenticated by the method and system described in this disclosure.

Further, the method and system disclosed in this disclosure can be used in identifying, certifying, and authenticating any game equipment associated with any game event in any sports game. For example, while the description focuses on identifying, certifying, and authenticating soccer balls, game items and event items may include one or more of sportswear (e.g., goalie gloves, jerseys, boxing gloves, shoes, etc.), equipment (e.g., a frisbee, a hockey puck, a goal net, a referee whistle, a baseball bat, etc.) turf grass, stadium seats (e.g., the red seat in Fenway Park), or the like.

In this sense, a “goal-scoring ball” is an exemplary type of an “event item” in this disclosure. Similarly, a “goal-scoring event” is an exemplary type of a “game event” in this disclosure as well.

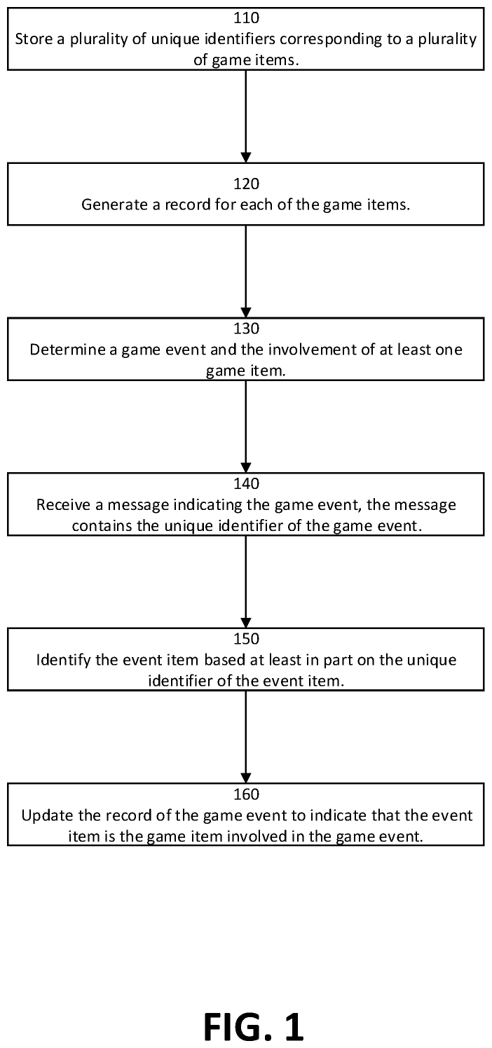

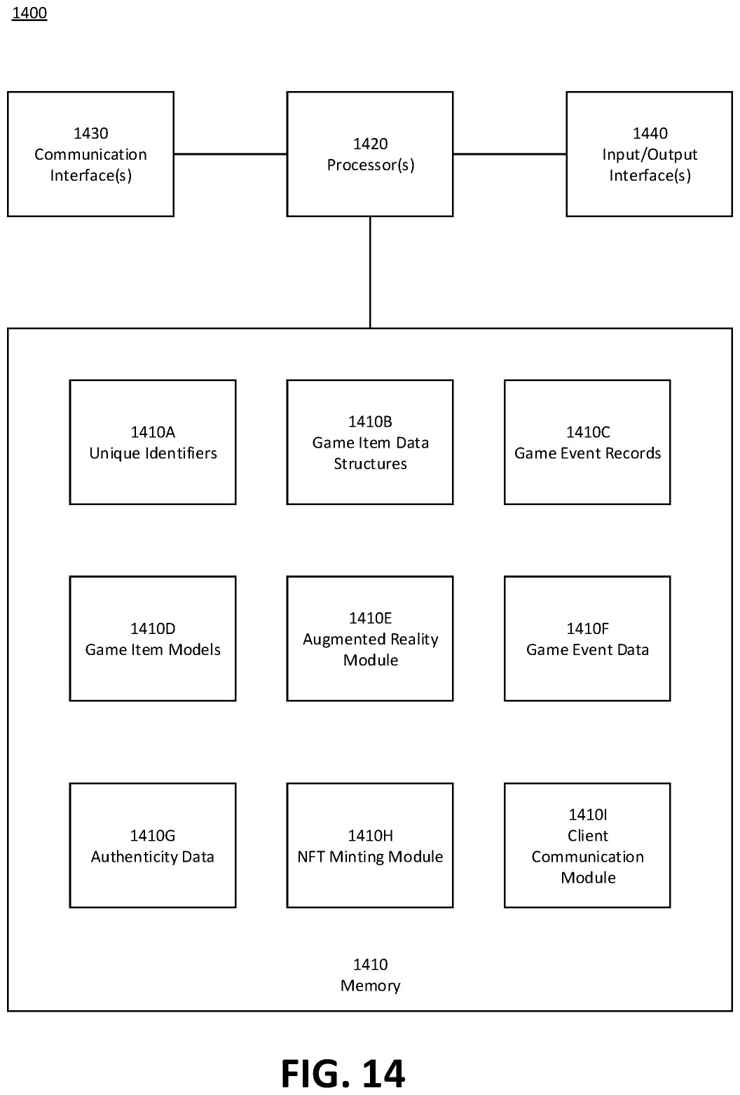

FIG. 1 illustrates a flowchart for certifying the authenticity of an event item in a game event according to an exemplary embodiment. In some embodiments, one or more steps of the flowchart in FIG. 1 may be performed by one or more modules in system 1400 (as shown in FIG. 14 and discussed in detail below) with processor(s) 1420 taking information/instructions through communication interface(s) 1430 and input/output interface(s) 1440 and executing instructions stored in a non-transitory memory 1410. In other embodiments, other devices, such as a smartphone or handheld scanner, may perform one or more steps of FIG. 1.

At step 110, the system 1400 stores a plurality of unique identifiers corresponding to a plurality of game items. In some embodiments, each unique identifier corresponds to a unique game item in the plurality of game items and may be implemented in a number of ways. For example, the plurality of unique identifiers may include a Quick Response (QR) code, a bar code, a serial number, a radio frequency identifier, or an infrared tag, among other technologies used for contactless or contact-based identification. In some embodiments, field workers may scan the game items with a handheld device (e.g., a personal digital assistant, kiosk, mobile device), and transfer the scanned unique identifiers to a server (e.g., through a wireless connection) for storage in a database.

In some embodiments, such a database may include a list of all possible identifiers for all game items which may be used during, for example, a season, a period of time, or a game. In other embodiments, such a database may include the identifiers only upon the use of a game item during a game (e.g., when a ball is first placed on the field/pitch with the intention of being used).

In some embodiments, the game item may include sensors to allow a tracking system to determine whether the item is being used in the game. In some embodiments, the sensor could be a GPS locator, an accelerometer, a gyroscope, etc., or a combination of them. For example, there are multiple identical soccer balls in a soccer game, but only one can be in active play. The system may determine which ball is the active ball by monitoring and comparing the movement status of the balls (e.g., speed, acceleration, spinning) or the location of the balls with regard to the field of play.

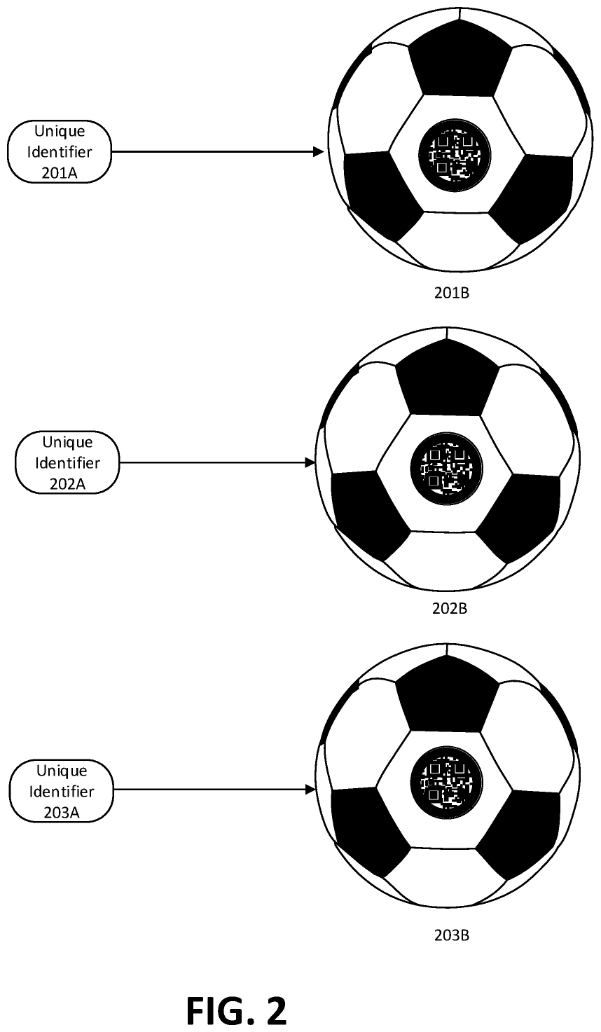

FIG. 2 illustrates an example of the correspondence between unique identifiers and game items (illustrated as soccer balls) according to an exemplary embodiment. For example, as shown in FIG. 2, unique identifier 201A corresponds to game item 201B, unique identifier 202A corresponds to game item 202B, and unique identifier 203A corresponds to game item 203B. In some embodiments, the unique identifiers themselves can be part of a game item data structure that corresponds to a game item, for example, by including a numerical representation of the unique identifier, a visual representation of the unique identifier, a serial number of the unique identifier, a numerical representation of the game item, a visual representation of the game item, a serial number of the game item, or the like. Additionally, system 1400 may store the unique identifiers in various formats in memory 1410. For example, the unique identifiers stored can be stored as some computed value based on a unique QR code corresponding to a game item (e.g., such as hash or other value). In some embodiments, rather than storing the unique identifiers themselves, system 1400 can store some verification or validation key that confirms the authenticity of a particular unique identifier.

In some embodiments, the identifiers may be non-unique or may be semi-unique. For example, two items may include a same identifier (e.g., a pair of shoes).

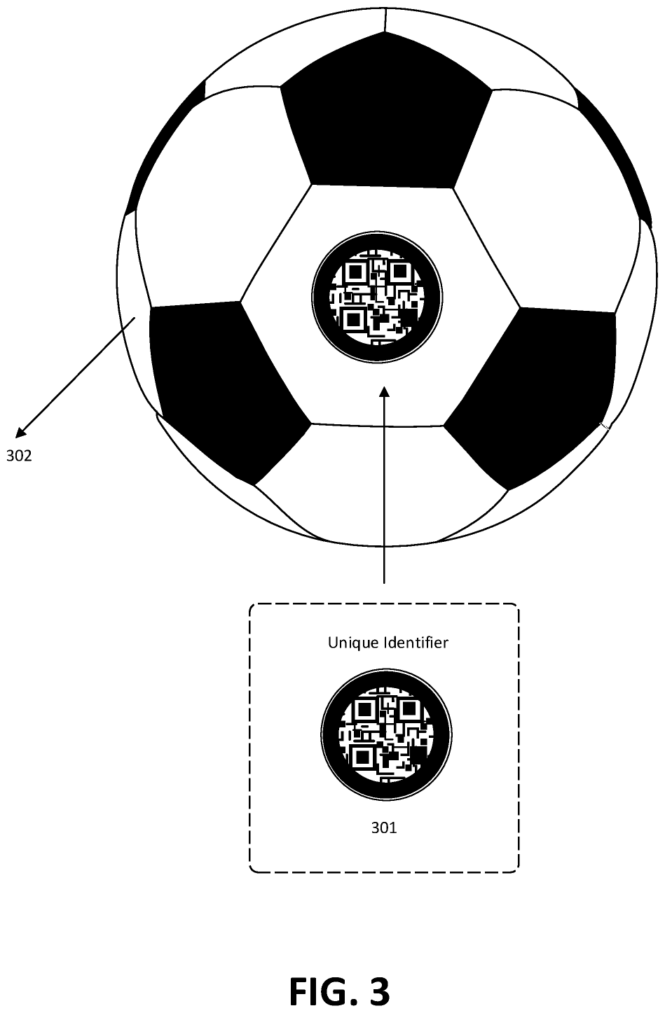

In addition to the unique identifiers stored on the system (e.g., in a memory of a database or server), each game item in the plurality of game items may include a physical representation of the unique identifier corresponding to that game item. FIG. 3 illustrates an example of a game item with a physical representation of a unique identifier according to an exemplary embodiment. As shown in FIG. 3, game item 302 (illustrated as a soccer ball) includes a representation of unique QR code 301.

In some embodiments, a game item may integrate the physical representation of the unique identifier corresponding to it. For example, the unique identifier can be printed directly on the game item or can be integral to the surface material of the game item.

Additionally or alternatively, in some embodiments, a game item may have the physical representation of the unique identifier corresponding it be affixed to it. For example, a self-deforming sticker with the unique identifier can be affixed to the game item. The self-deforming sticker may be constructed such that any attempt to remove the sticker results in the destruction/un-usability of the self-deforming sticker. In some embodiments, the self-deforming sticker can be configured to separate into pieces or fragments if a user attempts to remove it. Such physical representations may be affixed to a game item in advance of use during a game, may be affixed upon use during a game, or may be affixed upon creation of a game item.

In some embodiments, the unique identifier can be an identification chip housed inside each game item of the plurality of game items. For example, an identification chip may be housed inside a game item (e.g., soccer ball, American football, baseball, etc.) In some embodiments, a game item may comprise the identification chip in addition to or in place of the physical identifier.

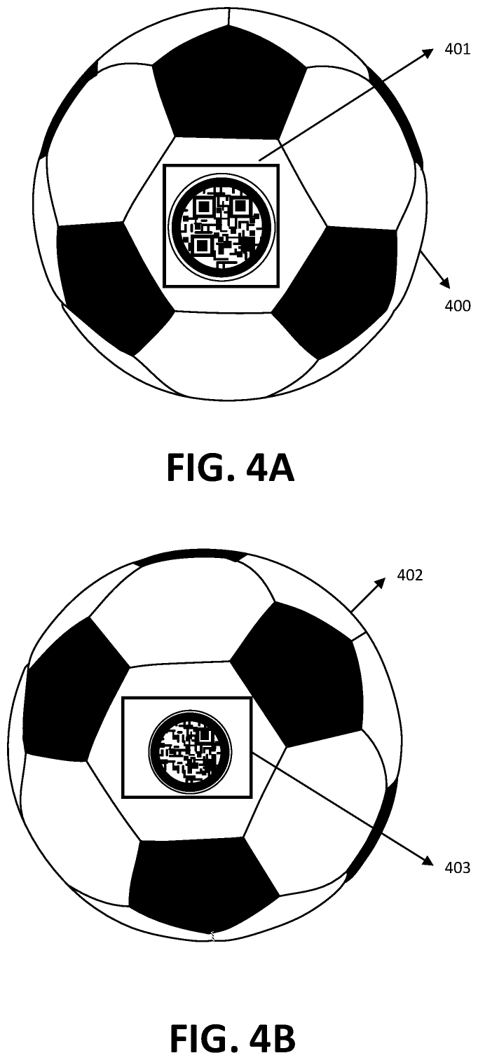

FIGS. 4A-4B illustrate exemplary embodiments of soccer balls with physical representations of unique identifiers according to an exemplary embodiment. Soccer ball 400 includes a unique QR code 401 that is integral to the soccer ball 400. Additionally, soccer ball 402 includes a unique QR code 403 that is part of a sticker affixed to the soccer ball 402.

Referring back to FIG. 1, in step 120, processor(s) 1420 may generate a record for each of the game items. In some embodiments, the record for a game item may include information regarding the game item. For example, the record may include a manufacturer, a specification, a serial code, a unique identifier of the game item, a picture of the game item, or the like. In some embodiments, the record for a game item may include information of the game. For example, the date and time of the game, the opposing player/team, the game officials, the competition, the weather, etc. In some embodiments, the information included in the records may be send in a message, discussed below.

At step 130, input/output interfaces 1440 may receive an indication that a game event has occurred and that at least one game item is involved in the game event. In some embodiments, processor(s) 1420 may use preset algorithm to determine a game event has occurred. For example, processor(s) 1420 may determine that a game event just occurred when there was a change in the score as indicated in a message sent by another system (e.g., a web server, or a device held by a referee/scorekeeper). In some other embodiments, a user may use his/her judgment to determine that a game event has occurred. For example, a user may notice a coach was dissenting fiercely with the game official and operate a user interface on a mobile device to send a message to system 1400 that a game event just occurred.

In some exemplary embodiments, in a scoring event in a soccer game, involved game items may be the scoring soccer ball, the scoring player's attire (e.g., jersey, shin guards, shoes, etc.), the involved defending player and their attire (e.g., jersey, shin guards, shoes, goalkeeper's gloves, etc.), the turf grass on which the scoring goal was shot, the goal net, etc. This information may be included, in some embodiments, in the message sent to input/output interfaces 1440.

In some exemplary embodiments, determining that a soccer ball crossed a goal line can include a remote device detecting a goal in a soccer game by scanning the unique identifier corresponding to the soccer ball. The remote device may be a device configured to detect the existence of a physical representation of a unique identifier, such as a video camera, RFID scanner, NFC scanner, Bluetooth receiver, or the like. The remote device may automatically scan the unique identifier of the soccer ball when the soccer ball passes beyond the goal line of the soccer goal and into the soccer goal. Alternatively, a user can scan the unique identifier of the soccer ball after the goal by, for example, clicking a physical button on the remote device, issuing a command on a computing device of the remote device, or by otherwise providing instructions to the remote device to scan the unique identifier of the soccer ball when it crosses the goal line. In other exemplary embodiments, a remote device can detect a goal in a soccer game by receiving tracking data from a tracking device of a soccer ball indicating that the soccer ball has crossed a goal line. The tracking data can correspond to the unique identifier corresponding to the soccer ball.

In some exemplary embodiments, in case of a soccer goal, a Goal-Line Technology system may determine if the soccer ball has crossed the goal line and subsequently communicate with the system that a game event (e.g., a scored goal) has occurred. Such a Goal-Line Technology system may be any system, such as the known Hawk-Eye or GoalControl systems. In some exemplary embodiments, the soccer ball may include accelerometers and gyroscopes configured to send information via a wireless network to enable a tracking system to determine that which soccer balls was in active play when a game event happened.

It is worth reiterating that game events need not be scoring events. Those without scoring can also be nevertheless of collectible value and thus be a game event in this context. In some other embodiments, a user may manually designate a game event. For example, in a baseball game, when a pitcher throws a record breaking fast ball, a user may utilize a mobile device to send a message to processor(s) 1420 through input/output interfaces 1440 to designate the pitch as a game event. The system and/or associated scanners may determine involved event items (e.g., the baseball pitched, the pitcher's attire, the catcher's gloves, the hitter's bat, the home base plate, etc.) and store their unique identifiers and their involvement in the game event into memory 1410.

At step 140, system 1400 may receive a message indicating the game event and the involved game items. In some embodiments, the message may be generated by another system or manually input by a user. In some embodiments, system 1400 may assign a unique identifier to the game event. In some embodiments, the message includes the unique identifier for the game event.

In some embodiments, such message links the unique identifier of the game event to the unique identifier of the event item, so that the event's unique identifier and the event items' unique identifiers are cross-referenced. In some embodiments, such message may contain data from a third-party information service provider. In some embodiments, system 1400 or another electronic device (e.g., used by a purchaser of a token associated with the event item) may utilize a unique identifier of the game event in a look-up process against a database to obtain the unique identifiers of the event items (e.g., the game items that were involved in the game event), to determine what the event items were. Such devices may also utilize a unique identifier of a game item and obtain the unique identifiers of the game events it was involved in (because a game item may be involved in multiple game events), and further knows which game events the game item has experienced.

Referring back to FIG. 1, at step 150, processor(s) 1420 may recognize and identify event items (i.e., the game items that involved in the game event) based at least in part on the unique identifier of the event item. In some embodiments, an authorized personnel may scan the unique identifier on a game item that is involved in a game event with a remote computing device (e.g., a smartphone, a handheld scanner, etc.) after the event occurred and sent to the server/systems of the event item authentication system (e.g., over a wireless or mobile network). In some embodiments, the unique identifier of the event item can also be input to the remote computing device in other ways, for example, by a remote user typing in a serial number, or by another system making such determination based on tracking the location and movement of the game item or scanning the unique identifier automatically.

In some embodiments, the message may include information relating to one or more of: the game itself, teams or parties of the game, scoring players; assisting players, one or more opponent players, or generally the players involved, the game officials, records or milestones associated with the game event, audio content, images, or audiovisual content relating to the game event. The message may also include hyperlinks or other links to that information, if stored on another device.

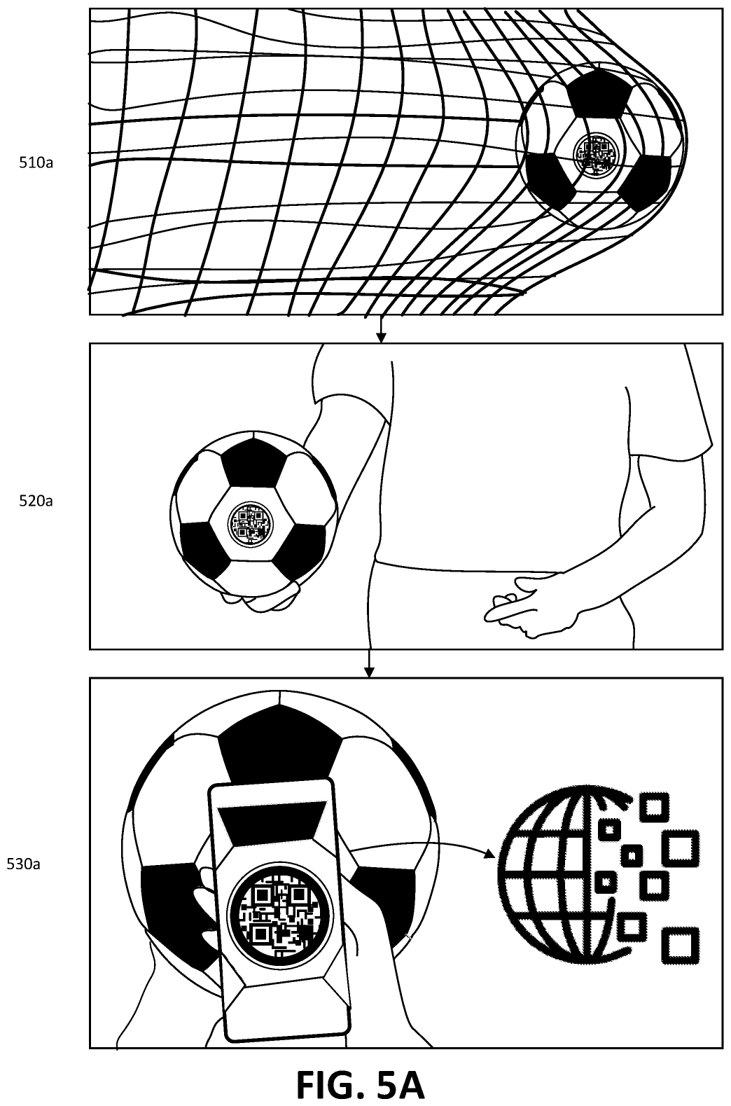

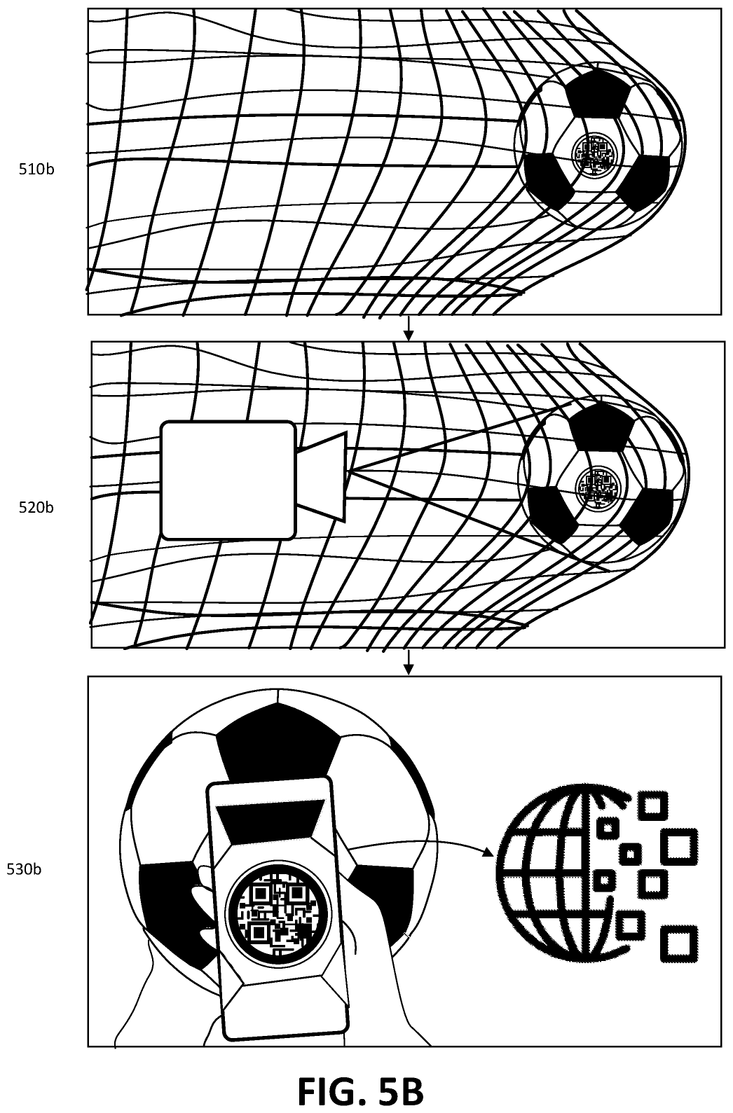

FIG. 5A illustrates an example of a process of sending and receiving a soccer goal scoring event message according to an exemplary embodiment. As shown in box 510a, a goal is scored when the ball crosses a goal line of a soccer goal and into the soccer goal. The referee or another designated official or user can then remove the scoring ball from the field of play, as shown in box 520a. In some embodiments, an authorized personnel may remove the ball from the game over the natural course of the match. For example, if the ball goes out of bounds then a ball boy may remove the ball from play and substitute it with a different ball for the next play (e.g., a throw-in, corner kick, goal kick, etc.). Finally, as shown in box 530a, an authorized personnel may scan the physical representation of the unique identifier on the goal scoring soccer ball that is scored (e.g., with a scanner or mobile phone application) or otherwise input the unique identifier for sending to a remote computing device, by packaging it into a message indicating that a goal was scored, and transmit the message to system 1400 or another system or database. In this embodiment, the physical representation of the unique identifier is affixed to each soccer ball before the ball is scored. In the example shown in FIG. 5A, the message indicating a goal is scored includes a scanned copy of the physical representation of the unique identifier.

In some embodiments, the event item may have the physical representation of a unique identifier affixed to it. In some embodiments, the unique identifiers may be stored unlinked to the plurality of game items, i.e., having the unique identifiers stored in a database, without affiliation to any specific game items. When a game event happens, and the involved event item is removed from the field of play, an authorized personnel may scan the unique identifier that is already affixed to the event item (e.g., with a scanner or mobile phone application) or otherwise input to a remote computing device. In some other embodiments, the physical representation of the unique identifier can be scanned or input into a remote computing device first and can be affixed to the event item after the game event has happened.

FIG. 5B illustrates another example of a process for sending and receiving the soccer goal scoring event message according to an exemplary embodiment. In this exemplary embodiment, the soccer ball that is scored is not removed from the field of play. As shown in box 510b, a goal is scored when the soccer ball crosses beyond a goal line of the soccer goal and into the soccer goal. As shown in box 520b, a remote device can register the soccer ball that is scored as a scoring ball. For example, the remote device can be a camera that scans a QR code on soccer ball that is scored and identify the soccer ball by a unique identifier corresponding to the soccer ball. The remote device can be a camera or other device configured to scan a unique identifier such as a QR code, and transmit it to the system 1400 (e.g., via Bluetooth, WiFi, etc.).

In some embodiments, the remote device can register the event item that is involved in the game event by detecting that a game item is spatially relevant to the game event. For example, a soccer ball can include a tracking device for monitoring a position of the soccer ball on the field of play. In some embodiments, the tracking device can be, but is not limited to, a chip or a radio frequency identification (RFID) tag, and may use any method for tracking, including but not limited to, radio frequency tracking, GPS and satellite tracking, Internet enabled tracking, and geofencing. In some embodiments, the soccer ball may be made with the tracking device. In some embodiments, the tracking device may be later attached to the soccer ball (e.g., with a chip or RFID tag inserted into the air valve of the soccer ball). In some embodiments, the remote device can receive tracking data from the tracking device of the game item indicating that the corresponding game item has proximity to the game event and movement pattern that matches the game event. As another example, the soccer goal can have one or more sensors that detect when the soccer ball crosses the goal line. The sensors can then send a message to the remote device indicating that the soccer ball has crossed the goal line of the soccer goal and into the soccer goal. Finally, as shown in box 530b, the unique identifier on the soccer ball can be packaged into a message that indicates a goal is scored and transmitted to the system server or database. In the example shown in FIG. 5B, the message indicating a goal is scored includes a scanned copy of the physical representation of the unique identifier.

In some embodiments, physical representation of a unique identifier can be affixed to the event item after the game item is determined to have involved in the game event.

Turning back to FIG. 1, at step 160, processor(s) 1420 may update a record corresponding to the unique identifier of the event item to indicate that the event item is involved in the game event. In some embodiments, at step 160, processor(s) 1420 may modify the event item's record to indicate that the item was involved in the game event. In some embodiments, processor(s) 1420 may generate and assign a unique identifier for the game event, and create a record for the game event indicating that the event involved the event items. In some embodiments, processor(s) 1420 may update both the records for the event and for the items to allow cross-reference between the records.

In some embodiments, a record for the game event is generated and linked to the unique identifier of the game event. The record for the game event may include information of the game event itself, e.g., date, time, exact location, the significance of the game event, etc. The record for the game event may also include the game items that involved in the game event, e.g., players (and their attire), officials, equipment, exact location(s) on the field of play, etc. For example, in a scoring event of a soccer game, the event record may be linked to the unique identifier of the event (e.g., goal scoring) and the record of the unique identifier of the soccer ball. The goal scoring record includes data indicating that the soccer ball was used in a particular goal scored in a soccer game. The goal scoring record can optionally include the goal scoring unique identifier. As discussed below, the goal scoring record can include additional information, such as authenticity data and goal scoring data. For example, the game event data is at least a part of the message and comprises one or more of information relating to one or more scoring players, information relating to one or more assisting players, information relating to a game in which the game event occurred, information relating to one or more opponent players, information relating to one or more players involved in the game event, information relating to one or more records or milestones associated with the game event, information relating to one or more game officials, information relating to one or more teams playing in a game in which the game event occurred, audio content relating to the game event, one or more images relating to the game event, or audiovisual content relating to the game event.

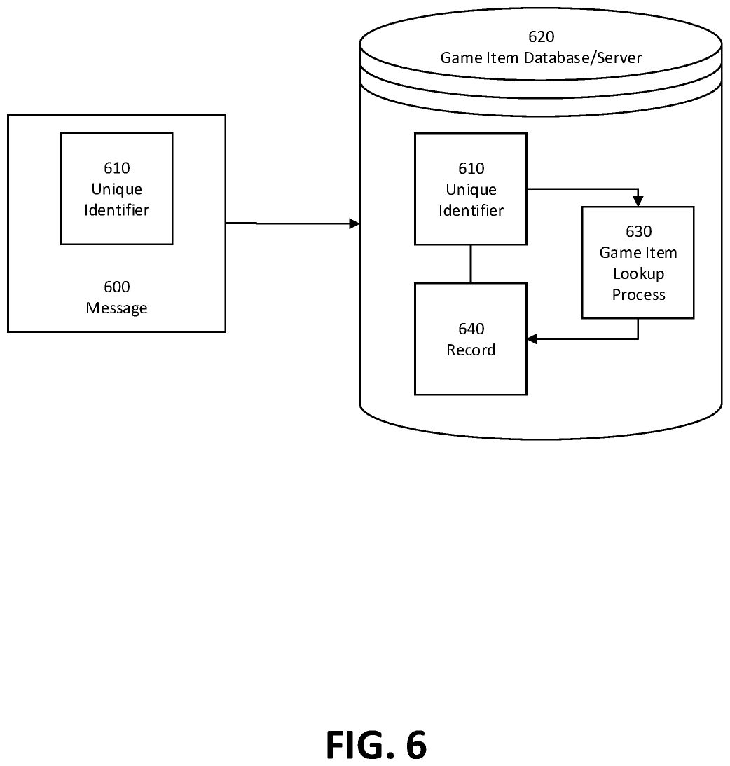

FIG. 6 illustrates an example of a soccer ball identification process and a goal scoring record generation process according to an exemplary embodiment. As shown in FIG. 6, message 600 including unique identifiers 610 is received by the game item database/server 620 through communication interface(s) 1430. In some embodiments, game item database/server 620 may be implemented as described substantially below with respect to FIG. 14. In some embodiments, processor(s) 1420 may pass the unique identifiers 610 to a game item lookup process 630. The game item lookup process 630 performs a lookup process by comparing the received unique identifiers 610 with the stored unique identifiers to identify which game items were involved in the game event. The game item lookup process 630 can validate that a received unique identifier 610 is a legitimate unique identifier associated with a true event item by examining the records associated with the unique identifier. At this moment, all legitimate game items should have a record in database/server 620 and a record associated with it. If a unique identifier appears to be new to database/server 620, processor(s) 1420 may consider it as an illegitimate unique identifier and fail the validation.

In some embodiments, processor(s) 1420 passing the unique identifiers 610 can be a part of game item lookup process 630.

In some embodiments, once the appropriate event item and unique identifier 610 are determined, game event record 640 is generated, indicating that the game items corresponding to unique identifiers 610 were involved in the game event (e.g., that the soccer ball corresponding to unique identifier 610 is a goal scoring ball). As shown in FIG. 6, record 640 is linked to unique identifier 610 (e.g., event record is linked to event's unique identifier, item record is linked to item's unique identifier.)

In some embodiments, message 600 that is sent by the remote device to game item database/server 620 with the unique identifier 610 can include one or more items of game event data relating to the game event itself. In some embodiments, one or more additional messages can be sent with the game event data. The one or more items of game event data can include information relating to one or more event items. In an exemplary embodiment, in case of a goal scoring event in a soccer game, the game event data may include information relating to one or more of a scoring player (e.g., name, number, biographical details, statistics, etc.), an assisting player (e.g., name, number, biographical details, statistics, etc.), a game in which the scoring event occurred (e.g., teams, current score at the time of the score), one or more opponent players (e.g., goalkeeper, defender, name, number, biographical details, statistics, etc.), the teams playing in a game in which the goal occurred (e.g., team name, logo, city, record, etc.), audio content relating to the goal scored in the soccer game (e.g., game audio, announcer audio, crowd noise, etc.), one or more images relating to the goal scored in the soccer game (e.g., pictures of the score, the scoring player, before and after events, etc.), and/or audiovisual content relating to the goal scored in the soccer game (e.g., video clips, gifs or other short video formats, with or without sound). The goal scoring record linked to the goal scoring unique identifier may contain one or more items of goal scoring data.

In some embodiments, message 600 that is sent by the remote device to game item database/server 620 with the unique identifier 610 can include one or more items of authenticity data relating to an authenticity of the event item itself. In some embodiments, one or more additional messages can be sent with the authenticity data. The one or more items of authenticity data can include one or more images of the event including the event item, audiovisual content of the game event including the event item, one or more images of the event item including its unique identifier, audiovisual content of the event item including its unique identifier, audiovisual content of the event item being removed from a field of play after the game event, and/or audiovisual content of a chain of custody of the event item after the game event. The one or more items of authenticity data can then be stored as part of the game event record linked to the game event unique identifier.

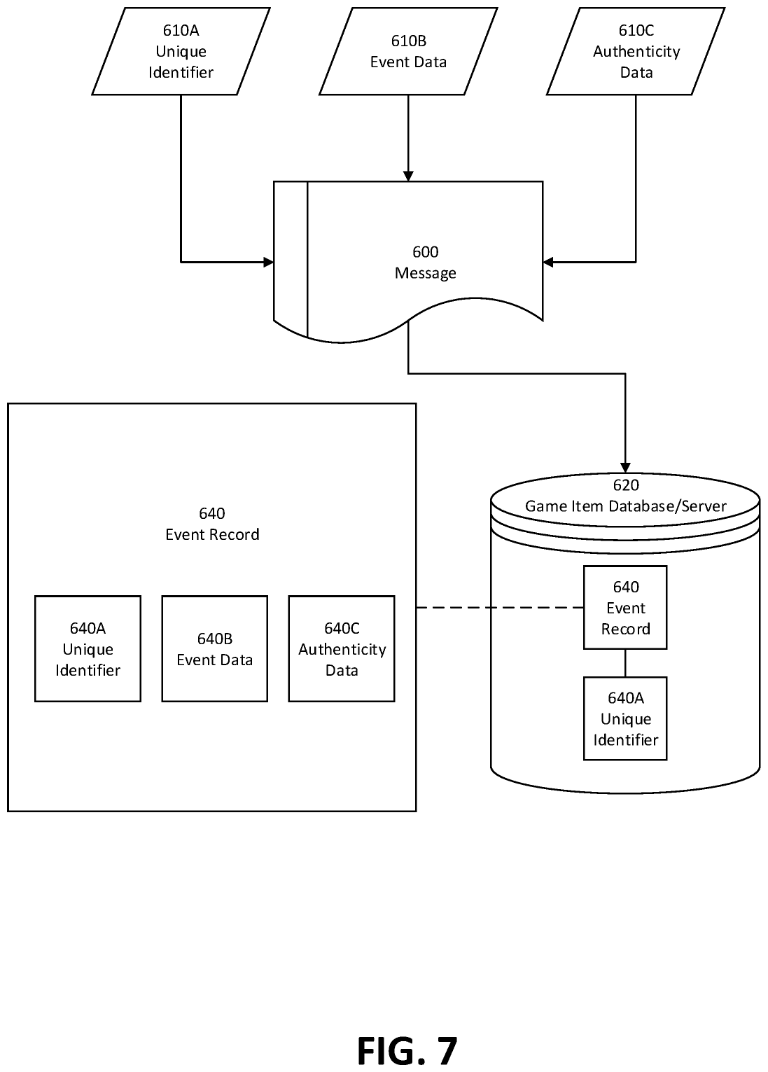

FIG. 7 illustrates an example of receiving game event data and authenticity data according to an exemplary embodiment. In some embodiments, message 600 may include unique identifier 610A, event data 610B, and authenticity data 610C. The message 600 may be transmitted to game item database/server 620 and is then parsed, formatted, and stored in the game item database/server as a game event record 640. As shown in FIG. 7, the game event record 640 may be linked to (or contain) its unique identifier 640A and contain game event data 640B and authenticity data 640C.

Ordinarily, event items are bought and sold by collectors. The present system provides users with the ability to prove ownership through a linkage of each event item with a token or digital asset, such as an NFT or other digital asset stored on or referred to by a blockchain/distributed ledger. The NFT itself functions as an asset and can be bought or sold by collectors independently from, or in conjunction with, the physical event item, by recording transactions against the ledger.

In some embodiments, while this application uses the term NFT or non-fungible token, other tokens or data (e.g., digital collectibles) may be used in place of an NFT as one of skill will recognize.

In some embodiments, a user may track the ownership on the game item server by recording and updating the current ownership of each event item in the game event record any time a transaction involving the event item occurs. For example, an encrypted file can store which users (e.g., name, username, password) are owners of event items.

An advantage of utilizing NFTs and a distributed ledger is that tracking of ownership by the game item server is not required. The server can query the blockchain to determine a current owner of any particular event item. For example, the server can store a mapping between unique identifiers corresponding to game items and NFT identifiers corresponding to the same game items. When a unique identifier is received, the corresponding NFT identifier can be used to look up ownership.

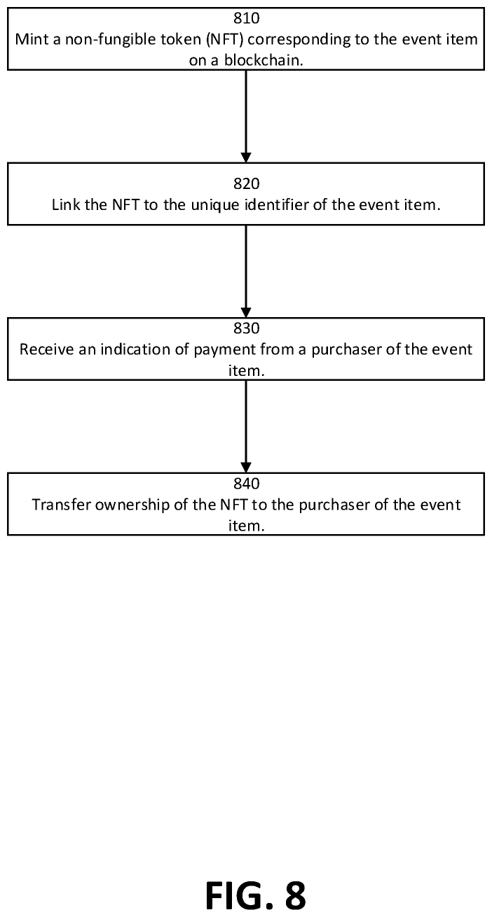

FIG. 8 illustrates a flowchart for linking the event item to an NFT and transferring ownership of the NFT according to an exemplary embodiment. At step 810, processor(s) 1420 may mint an NFT corresponding to the event item on a blockchain (e.g. a distributed ledger). The blockchain can be any suitable chain, such as the Ethereum chain, a sidechain of another chain, or a private blockchain. In some embodiments, the NFT corresponding to the event item can be minted in a number of ways. In some embodiments, minting is the creation of a digital asset and recordation against a distributed ledger. Processor(s) 1420 first generates a cryptographically unique token corresponding to the game item being minted into NFT, inserts information associated with the cryptographically unique token onto a distributed leger, and then links the cryptographically unique token to the unique identifier of the game item. The NFT can be minted based at least in part on the unique identifier of the event item, information in the record of the event item, or some combination of the two. For example, a photograph of the event item with the unique identifier can be used as the digital file input to the NFT minting process. In some embodiments, the NFT can be minted based on an arbitrary digital file. In some embodiments, the NFT can be minted before the game for one or more game items.

In some embodiments, processor(s) 1420 may selectively determine what information from the record may be used to insert onto the distributed leger. In some embodiments, space available for a cryptographically unique token on the distributed leger is limited. Processor(s) 1420 may select what information to use or prioritzed to be used from the record based on the type of item and/or event. For example, for an NFT associated to a jersey, information regarding who worn it in what match and the milestones it experienced is important and thus should be prioritized when the NFT is being minted; for a soccer ball, information regarding the scoring event it experienced is important and thus should be prioritized when the NFT is being minted.

In some embodiments, processor(s) 1420 may insert information regarding the scanning of the event item itself onto the distributed leger when minting the NFT. In some embodiments, the scanning action itself may be a critical step of the chain of custody in authenticating the event item.

In some embodiments, upon initial minting, the NFT can be associated with a private key (e.g., a “crypto wallet”) of an administrator of the game item server or an account associated with the game item server. The private key holder is the owner of the NFT. This means that the game item server can be the initial owner of the NFT. In some embodiments, a third party could be used to mint the NFT and act as the initial owner/custodian of the NFT.

In some embodiments, the NFT can be a soul bound NFT. A soul bound NFT is a non-transferable NFT, meaning that it cannot be given away or taken from the owner. When the NFT that is minted corresponding to the event item is a soul bound NFT, the ownership of that soul bound NFT cannot be transferred to another owner. In some embodiments, the soul bound NFT can be embedded in the game item in the form of, for example, a chip, an RFID tag, a QR code, a bar code, or the like.

At step 820, processor(s) 1420 may link the minted NFT to the unique identifier of the game event. The minted NFT can be associated with the event item and/or the corresponding unique identifier in a number of ways. For example, the NFT metadata (i.e., a set of data that makes up the content of the NFT) can include information about the event item, the game event, the authenticity of the event item, or the unique identifier of the event item, many of which overlap with the information in the record of the associated event item. In this case, the minting step and the linking step are performed at the same time—the relevant metadata is provided to the minting process. Additionally, or alternatively, the game item server can store a mapping between each NFT identifier and a unique identifier of a corresponding game item.

At step 830, processor(s) 1420 may receive an indication of payment from a purchaser of the goal scoring soccer ball. In some embodiments, this can be the initial purchaser of the actual physical event item. In some embodiments, the indication of payment can be a payment confirmation, credit card transaction, cash settlement, or some other financial transaction. In some embodiments, the indication of payment may be on a blockchain/distributed ledger, but the system 1400 may nevertheless store it in memory 1410 for future uses (e.g., deciding physical item's ownership, discussed below).

At step 840, processor(s) 1420 may transfer the ownership of the NFT to the purchaser of the event item based at least in part on receiving the indication of payment. In some embodiments, processor(s) 1420 may use a private key of the current owner (e.g., the game item server, another administrator, or a custodian) to sign the transaction. The purchaser may then take ownership of the NFT (i.e., has his/her private key to the NFT or “in his/her digital wallet”).

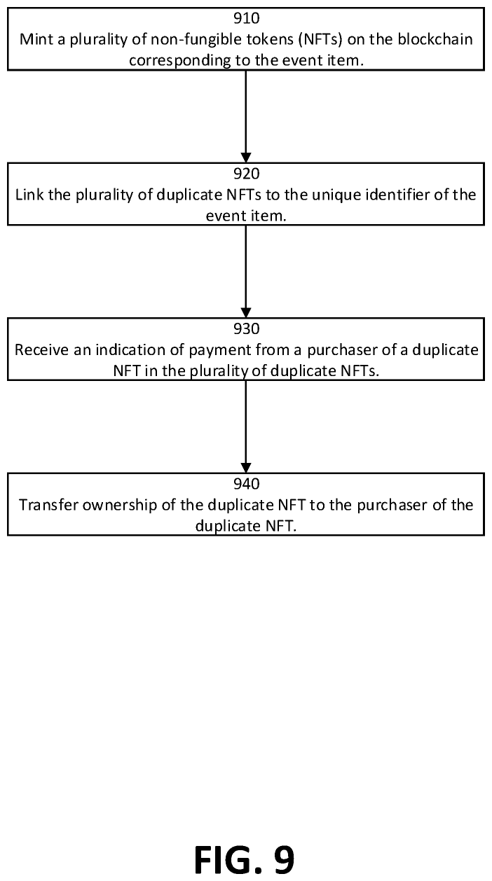

FIG. 9 illustrates a flowchart for linking the goal scoring soccer ball to a plurality of duplicate NFTs and transferring ownership of the duplicate NFTs according to an exemplary embodiment. This process is similar to that shown in FIG. 8, with some minor differences. At step 910, processor(s) 1420 may mint a plurality of duplicate non-fungible tokens (NFT) corresponding to the event item on a blockchain (e.g. a distributed ledger). The blockchain can be any suitable chain, such as the Ethereum chain, a sidechain of another chain, or a private blockchain.

The duplicate NFTs corresponding to the event item can be minted in a number of ways. In some embodiments, processor(s) 1420 may mint the duplicate NFTs based at least in part on the game event unique identifier, information in the event item record, or some combination of the two. For example, processor(s) 1420 may use a photograph of the event item with the unique identifier as the digital file input to the NFT minting process. In some embodiments, processor(s) 1420 may mint the duplicate NFTs based on arbitrary digital files.

In some embodiments, upon initial minting, the duplicate NFTs can be associated with a private key (e.g., a “crypto wallet”) of an administrator of the game item database/server or an account associated with the game item server. The private key holder is the owner of the NFT. This means that the game item server can be the initial owner of the duplicate NFTs. In some embodiments, a third party could be licensed to mint the duplicate NFTs and act as the initial owner/custodian of the duplicate NFTs.

In some embodiments, processor(s) 1420 may disclose the number of duplicate NFTs minted. In some embodiments, processor(s) 1420 may assign a serial number to each of the duplicated NFTs. An owner of the duplicate NFT may know the scarcity of the duplicate NFTs dispite them being “duplicate.” Disclosing the total number of duplicate NFTs may also help the processor(s) 1420 (and potential buyers as well) to determine the value of the duplicate NFTs.

At step 920, processor(s) 1420 of system 1400 may link the minted duplicate NFTs to the game event unique identifier. In some embodiments, the minted duplicate NFTs can be associated with the event item and/or the corresponding unique identifier in a number of ways. For example, the NFT metadata for each duplicate NFT can include information about the event item, the game event, the authenticity of the event item, or the unique identifier of the event item. In this case, the minting step and the linking step are performed at the same time—the relevant metadata is provided to the minting process. Additionally, or alternatively, the game item server can store a mapping between each NFT identifier of each duplicate NFT and a unique identifier of a corresponding event item.

At step 930, processor(s) 1420 of system 1400 may receive an indication of payment from a purchaser of a duplicate NFT. In some embodiments, unlike the initial (or primary) NFT, the duplicate NFTs can be sold or otherwise distributed independently of the event item and do not denote ownership of the event item. However, as discussed further below, the duplicate NFTs can confer privileges on their owners on the game item server. In some embodiments, the indication of payment can be a payment confirmation, credit card transaction, cash settlement, or some other financial transaction.

At step 940, processor(s) 1420 of system 1400 may transfer the ownership of the duplicate NFT to the purchaser of the event item based at least in part on receiving the indication of payment. In some embodiments, this transaction can be performed using a private key of the current owner (e.g., the game item server, another administrator, or a custodian) to sign the transaction. The duplicate NFT is then associated with the crypto wallet of the purchaser.

In some embodiments, the game item database/server as a platform can provide various services to users, including lookup of game items and game event data associated with game items, lookup of authenticity information, lookup of ownership information, etc. In some embodiments, the game item databasse/server can also generate three-dimensional models of the game item and allow users to view and interact with the three-dimensional models. In some embodiments, the system may grant certain users special privileges with respect to the three-dimensional model. For example, users owning an NFT or duplicate NFT can be given the privilege of importing and/or interacting with the three-dimensional model in an augmented reality application.

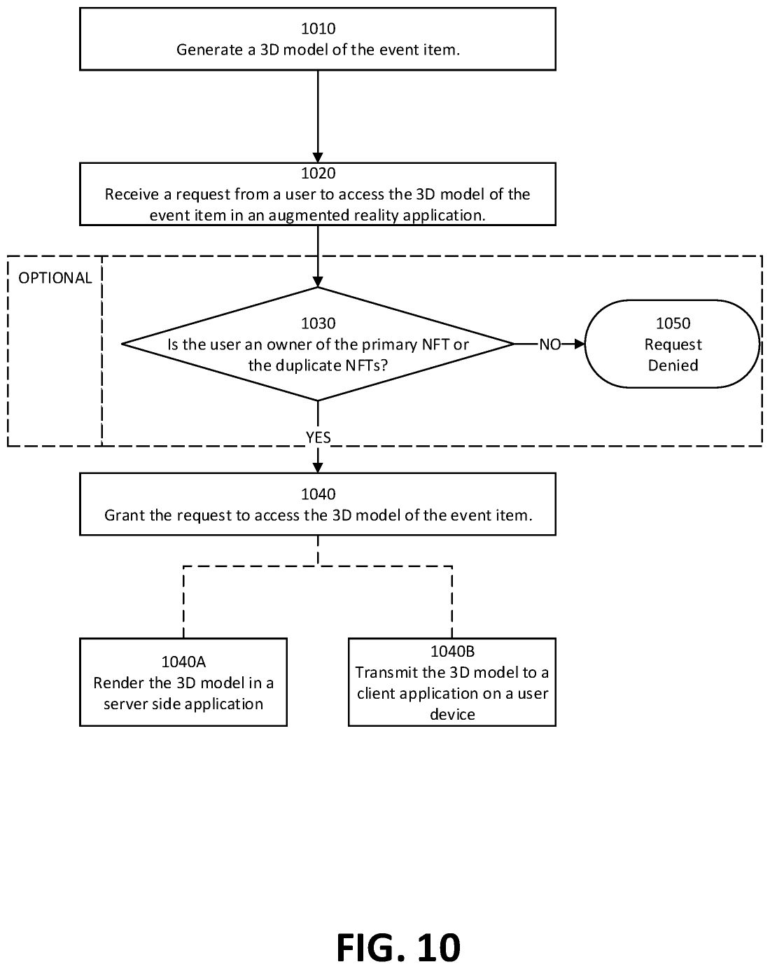

FIG. 10 illustrates a flowchart for granting users access to a three-dimensional model of an event item according to an exemplary embodiment. In some embodiments, at step 1010, the system may generate a three-dimensional model of the event item. In some embodiments, the model can be generated based on photos of the event item from multiple angles, preexisting models, and/or scanning of the event item.

At step 1020, processor(s) 1420 of system 1400 may receive a request from a user to access the three-dimensional model of the event item in an augmented reality application. In some embodiments, the request can include the unique identifier of the event item and, optionally, a user identifier or other user information. In some embodiments, the augmented reality application can be a client-side application on the user's device and/or an application hosted on a server, such as the game item server.

At step 1040, processor(s) 1420 of system 1400 may grant the request to access the three-dimensional model of the event item and provide the user with access to the three-dimensional model in the augmented reality application. In some embodiments, the user, upon getting the access to the three-dimensional model of the event item, may interact with the event item in the augmented reality application on their device. For example, a user may access the three-dimensional model of a soccer ball and play the ball in an augmented reality environment. In some embodiments, the model may be stored in a standardized file format, including, for example, 3DS files, BLEND files, CAD files, COLLADA files, FBX files, glTF files, GLB files, IGES files, OBJ files, STL files, USDZ files, VRML files, or other file formats enabling three-dimensional modeling (e.g., in an augmented reality application and/or other rendering, including physical rendering).

In some embodiments, users may in their augmented reality application access the NFT to confirm the authenticity of their rendering.

In some embodiments, this feature can be reserved for users with special privileges, such as the owner of the primary NFT or one of the duplicate NFTs. In this case, then at step 1030 (after step 1020) processor(s) 1420 of system 1400 may determine whether the user is an owner of the primary NFT or the duplicate NFTs corresponding to the event item.

As discussed earlier, processor(s) 1420 of system 1400 may perform the access check by looking up the NFT identifier and/or duplicate NFT identifiers based on the unique identifier in the request and querying the blockchain for the current owners. Processor(s) 1420 of system 1400 may search current owners' user information/user identifier in the event item's record to determine if the user is a current owner. In some embodiments, system 1400 may directly connect to the user's digital wallet or other storage for an NFT and validate/probe the veracity of the NFT ownership. In some embodiments, system 1400 may consult on other data (e.g., a database, an external information source, etc.) to determine if the user is a current owner.

In this exemplary embodiment, if the user is not an owner of either the primary NFT or the duplicate NFTs, then at step 1050, processor(s) 1420 of system 1400 may deny the request from the user. If the system cannot determine whether the user is an owner (e.g., user information was not provided), then processor(s) 1420 of system 1400 may also deny the request. If the user is an owner of the primary NFT or one of the duplicate NFTs, then at step 1040, processor(s) 1420 of system 1400 may grant the user request to access the three-dimensional model of the event item in an augmented reality application based at least in part on a determination that the user is an owner of the NFT or a duplicate NFT in the plurality of duplicate NFTs.

In some embodiments, regardless of whether the user is required to have an NFT/duplicate NFT or not, step 1040 can include sub-step 1040A and/or sub-step 1040B. At step 1040A, processor(s) 1420 of system 1400 may render the three-dimensional model of the event item in a server-side application and make it accessible to the user on a corresponding client-side device (e.g., via a browser applet or mobile app). At step 1040B, processor(s) 1420 of system 1400 may transmit the three-dimensional model of the event item to an application on a device of the user. In this case, the model is not rendered server side but the data for the model is sent to the user device and rendered locally.

In some embodiments, processor(s) 1420 may sell or assign the physical event item. In some embodiments, processor(s) 1420 may define a group of people and allow one in the group to participate in a raffle. The definition of the “group” can have additional criterion. For example, the group may include only those who purchased the NFT or duplicate NFT associated with the item being raffled. In some embodiments, the raffle process may happen after the NFT and duplicate NFTs are sold or assigned, and only those who owns the NFT or a duplicate NFT can participate. In some embodiments, there can be a separate entry for the raffle with related or unrelated entering criteria. In some embodiments, the raffle can be random.

In some embodiments, for purposes of determining who would take ownership of the physical event item, processor(s) 1420 may create a decentralized automatic organization (DAO) for each of the physical event item in need of a decision on ownership. In some embodiments, the DAO may have a membership. All members of the DAO may have the power to decide by a vote who would own the physical event item. In some embodiments, the membership of the DAO may include all buyers of the corresponding NFT (e.g., primary NFT, duplicate NFT.)

In some embodiments, the DAO may vote to decide where the physical event item goes. In some embodiments, the decision may be to assign the physical event item to a person. In some embodiments, the decision may be to put the physical item on display to the public (e.g., in a museum.) In some embodiments, the decision may be to give the physical event item to whoever has the most NFTs and/or digital collectibles associated with that event item. In some embodiments, the rules and options of the DAO may be further negotiated and decided by its members.

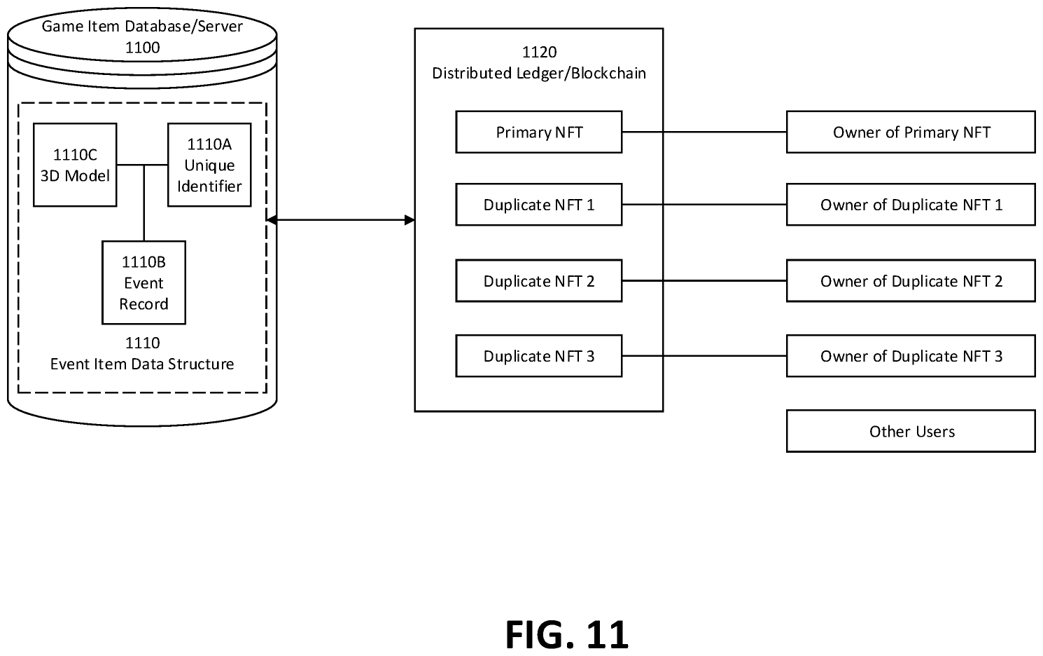

FIG. 11 illustrates a system diagram of the game item database/server, the corresponding NFTs, and corresponding user access rights according to an exemplary embodiment. In some embodiments, game item database/server 1100 can optionally include an event item data structure to act as a container for all data pertaining to a particular event item. In some embodiments, this data structure may be omitted. In some embodiments, game item database/server 1100 may be implemented as described substantially below with respect to FIG. 14.

In some embodiments, game item database/server 1100 may include a unique identifier 1110A, event record 1110B, and 3D model 1110C, all of which are linked together (i.e., cross-referenced in the database/server 1100) so that any system/device accessing the database/server 1100 may use one of the three to find the other two. For example, a user device may access 3D model 1110C if it has either corresponding unique identifier 1110A or corresponding event record 1110B; a user device may access event record 1110B if it has either corresponding unique identifier 1110A or corresponding 3D model 1110C; a user device may access unique identifier 1110A if it has either corresponding event record 1110B or corresponding 3D model 1110C.

In some embodiments, each event item (e.g., unique identifier) is linked to corresponding NFTs on a distributed ledger/blockchain 1120. In this exemplary embodiment, there are one primary NFT and three duplicate NFTs. Each of the NFTs may have ownership and corresponding privileges according to the exemplary embodiment. For example, the owner of the primary NFT may have special access to the 3D model (e.g., in an augmented reality application), access to the game event record, and physical possession of the event item. The owners of the duplicate NFTs do not have physical possession of the event item but may have the other privileges, for example, special access to the 3D model. A user that does not have any NFTs may have some access to the 3D model (e.g., viewing, limited interaction) and access to the game event record.

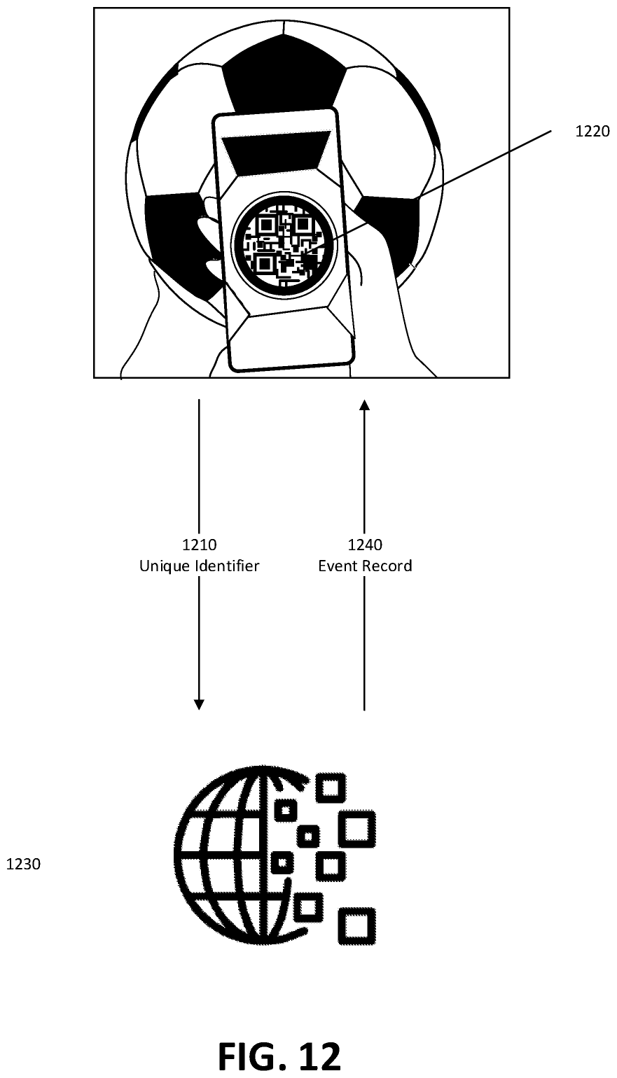

FIG. 12 illustrates a method for retrieving a game event record according to an exemplary embodiment. In some embodiments, as shown in FIG. 12, a user may use his/her device 1220 to retrieve and verify the authenticity of the event item. In some embodiments, the user may use his/her device 1220 (e.g., a smart phone) to capture the unique identifier of the game item (e.g., from an image, website, or the physical game item) and transmits the unique identifier 1210 of the game event to the game item database/server 1230. The game item database/server 1230 may receive the unique identifier 1210 from the user device 1220. The game item database/server 1230 then may transmit at least a portion of the game event record 1240 linked to the game event's unique identifier 1210 to the user device 1220. In some embodiments, the system 1400 may send the game event record data on the user device 1220 in, for example, a mobile application executing on the user device 1220 or in a web browser of a browser executing on the user device 1220.

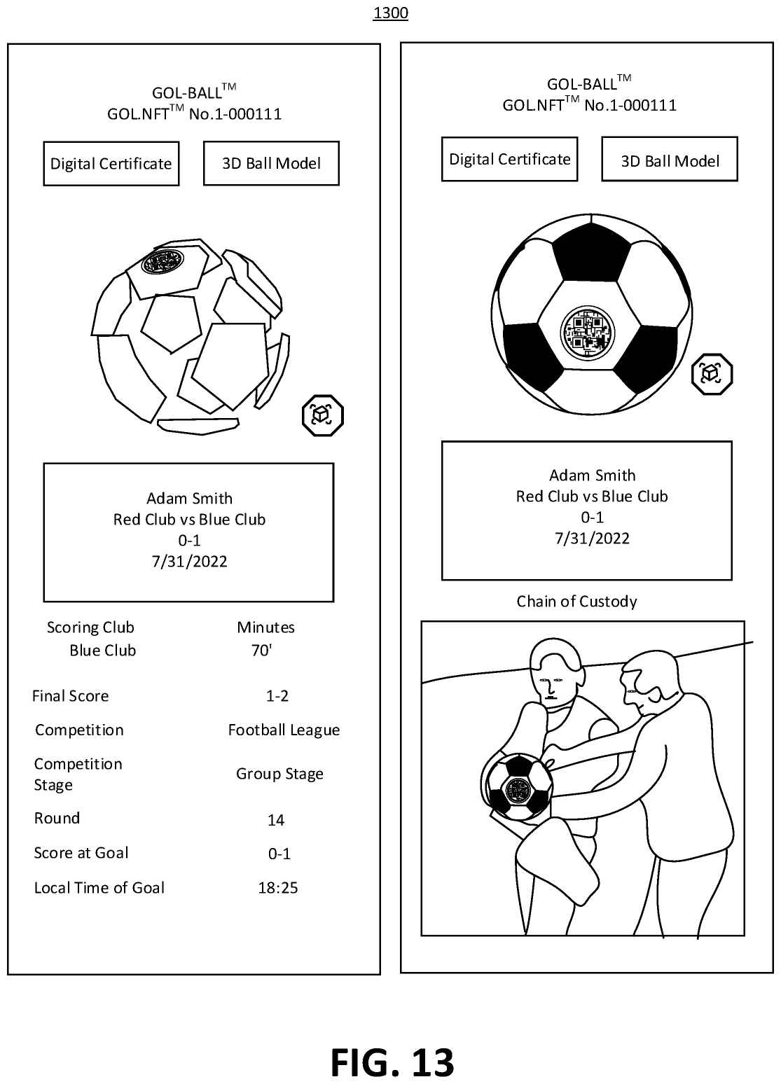

FIG. 13 illustrates an exemplary embodiment of a game event record presentation 1300 linked to the game event's unique identifier. This exemplary embodiment has a game event of a goal in a soccer game. As shown in FIG. 13, presentation 1300 generated according to the game event (goal scoring) record includes match information, team information, scoring player information, goal scoring details, description of the goal scoring, video content of the goal scoring (e.g., a GIF and other video) and video evidence of the chain of custody after the goal scoring. In some embodiments, the video content and evidence may rely on media coverages.

One or more of the above-described techniques can be implemented in or involve one or more special-purpose computer systems having computer-readable instructions loaded thereon that enable the computer system to implement the above-described techniques. FIG. 14 illustrates an example of a system 1400 that can be used to implement the above-described processes according to some embodiments. The system 1400 is not intended to suggest any limitation as to scope of use or functionality of a described embodiment(s).

In some embodiments, system 1400 includes at least one processing unit/controller 1420 and memory 1410. Processing unit 1420 executes computer-executable instructions and can be a real or a virtual processor. In a multi-processing system, multiple processing units execute computer-executable instructions to increase processing power. Memory 1410 can be volatile memory (e.g., registers, cache, RAM), non-volatile memory (e.g., ROM, EEPROM, flash memory, etc.), or some combination of the two. Memory 1410 can store software and data used for implementing the above-described techniques, including unique identifiers 1410A, game item data structures 1410B, game event records 1410C, game item models 1410D, augmented reality module 1410E, game event data 1410F, authenticity data 1410G, NFT minting module 1410H, and client communication module 1410I.

All of the software stored within memory 1410 can be stored as computer-readable instructions, that when executed by processor(s) 1420, cause the processor(s) 1420 to perform the functionality described with respect to FIGS. 1-13.

Processor(s) 1420 may execute computer-executable instructions and can be a real or virtual processors. In a multi-processing system, multiple processors or multicore processors can be used to execute computer-executable instructions to increase processing power and/or to execute certain software in parallel.

System 1400 additionally includes a communication interface 1430, such as a network interface, which is used to, through processor(s) 1420, communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example without limitation, communication media include wired or wireless techniques implemented with an electrical, optical, RF, infrared, acoustic, or other carrier.

System 1400 further includes input and output interfaces 1440 that allow users (such as system administrators) to provide input to the system to set parameters, to edit data stored in memory 1410 through processor(s) 1420, or to perform other administrative functions.

An interconnection mechanism (shown as a solid line in FIG. 14), such as a bus, controller, or network interconnects the components of the system 1400.

Input and output interfaces 1440 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the system 1400.

System 1400 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 2800.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Disclosed embodiments may include any one of the following bullet-pointed features alone or in combination with one or more other bullet-pointed features, whether implemented as a method, by at least one processor, and/or stored as executable instructions on non-transitory computer readable media:
storing a plurality of unique identifiers corresponding to a plurality of game items, generating a record for each of the plurality of unique identifiers;
determining a game event and the involvement of at least one event item;
receiving a message indicating the game event, the message comprising the unique identifier of the at least one event item;
identifying the at least one event item based at least in part on the unique identifier of the event item;
updating the record of the at least one event item to indicate that the event item is the game item involved in the game event;
storing game event data in the record of the at least one event item linked to the unique identifier of the at least one event item;
storing authenticity data in the record of the at least one event item linked to the unique identifier of the at least one event item;
generating a cryptographically unique token corresponding to the at least one item;
inserting information associated with the cryptographically unique token onto a distributed ledger;
linking the cryptographically unique token to the unique identifier of the at least one event item;
receiving an indication of payment from a purchaser of the at least one event item;
transferring ownership of the cryptographically unique token to the purchaser of the at least one event item;
generating a three-dimensional model of the at least one event item;
receiving a request from a user to access the three-dimensional model of the at least one event item in an augmented reality application;
determining whether the user is an owner of the token or a duplicate token in the plurality of duplicate tokens;
granting the request to access the three-dimensional model of the at least one event item based at least in part on a determination that the user is an owner of the token or a duplicate token in the plurality of duplicate tokens;
generating a three-dimensional model of the at least one event item;
receiving a request from a user to access the three-dimensional model of the at least one event item;
granting the request to access the three-dimensional model of the at least one event item;
rendering the three-dimensional model of the at least one event item in an application hosted on at least one of the one or more computing devices;
transmitting the three-dimensional model of the at least one event item to an application on a device of the user;
receiving the unique identifier of the at least one event item from a user device; transmitting at least a portion of the record of the at least one event item to the user device;
identifying game events using electronic sensors, inputs from user devices, metadata, or data received from external services;
generating and maintaining a record for game items and game events;
communicating with another system regarding game events;
certifying authenticity of game items involved in game events;
creating, selling, and registering NFTs or digital token/collectible associated with game items;
verifying NFT or digital tokens/collectibles ownership;
assigning/selling and delivering physical game items based on associated NFT or digital token/collectible ownership;
recording a ball or game item or event item photographically from the game event (e.g., goal) until taken into custody;
temporarily exhibiting the ball or game item or event item for the public in the stadium, in some embodiments under supervision of the commissioner, and tracking such exhibition via data storage in blockchain/distributed ledger entries;
identifying and/or certifying the ball or game item or event item by QR, NFC, visual, non-visual, electronic, contactless, or contact-based technology;
configuring parameters for the creation of a contract, including for example, the number of copies of an NFT or digital collectible/token, the price of each NFT or digital collectible/token;
registering the contract in a blockchain/distributed ledger including photos of the chain of custody, a three-dimensional model of the ball or game item or event item, audio, video, photo, picture data, or other multimedia files;
closing and registering a contract;
enabling viewing of the ball or game item or event item even if the contract is incomplete;
registering the contract;
minting and delivering an NFT or digital token/collectible;
storing an NFT/digital token/collectible into a user's account;
enabling a user to select the number of the collectible, e.g., from 1 to n, where n is the quantity authorized to be sold, without enabling duplicates; or enabling delivery of the physical ball or game item or event item by random assignment (e.g., a random process through a contract in the blockchain that will assign the winning piece number to which the ball or game item or event item will be delivered, the number corresponding to the unique identification of the collectible, or through a DAO as discussed above.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

While methods, apparatuses, and computer-readable media are described herein by way of examples and embodiments, those skilled in the art recognize that methods, apparatuses, and computer-readable media for identifying and certifying authenticity of a game event item in a sports game are not limited to the embodiments or drawings described. It should be understood that the drawings and description are not intended to be limited to the particular form disclosed. Rather, the intention is to cover all modifications, equivalents, and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” and “includes” mean including, but not limited to.

We claim:

1. A method executed by one or more computing devices for identifying and certifying authenticity of a game item in a sports game, the method comprising:
storing a plurality of unique identifiers corresponding to a plurality of game items, each unique identifier corresponding to a unique game item in the plurality of game items;
generating a record for each of the plurality of unique identifiers;
determining a game event and the involvement of at least one event item, wherein the at least event item is a game item of the plurality of game items;
receiving a message indicating the game event, the message comprising the unique identifier of the at least one event item;
identifying the at least one event item based at least in part on the unique identifier of the event item; and
updating the record of the at least one event item to indicate that the event item is the game item involved in the game event.

2. The method of claim 1, wherein the plurality of unique identifiers comprise one or more of:
a Quick Response (QR) code;
a bar code;
a serial number;
a radio frequency identifier; or
a infrared tag.

3. The method of claim 1, wherein the game event is a scoring event and the at least one event item comprises a game ball.

4. The method of claim 1, wherein each game item in the plurality of game items comprises a physical representation of the unique identifier corresponding to that game item, wherein the physical representation of the unique identifier corresponding to each game item is integral to, affixed to, or inside that game item.

5. The method of claim 4, wherein the message indicating the game event comprises a scanned copy of the physical representation of the unique identifier of the at least one event item.

6. The method of claim 1, further comprising storing game event data in the record of the at least one event item linked to the unique identifier of the at least one event item;
wherein the game event data is at least a part of the message and comprises one or more of:
information relating to one or more scoring players;
information relating to one or more assisting players;
information relating to a game in which the game event occurred;
information relating to one or more opponent players;
information relating to one or more players involved in the game event;
information relating to one or more records or milestones associated with the game event;
information relating to one or more game officials;
information relating to one or more teams playing in a game in which the game event occurred;
audio content relating to the game event;
one or more images relating to the game event; or
audiovisual content relating to the game event.

7. The method of claim 1, further comprising storing authenticity data in the record of the at least one event item linked to the unique identifier of the at least one event item;
wherein the authenticity data relates to an authenticity of the at least one event item and is at least a part of the message, the authenticity data comprises one or more of:
content relating to a chain of custody of the at least one event item after the game event;
one or more images of the game event including the at least one event item;
audiovisual content of the game event including the at least one event item;
one or more images of the at least one event item including the unique identifier of the at least one event item;
audiovisual content of the at least one event item including the unique identifier of the at least one event item;
audiovisual content of the at least one event item being removed from a field of play after the game event; or
audiovisual content of a chain of custody of the at least one event item after the game event.

8. The method of claim 1, further comprising:
generating a cryptographically unique token corresponding to the at least one item;
inserting information associated with the cryptographically unique token onto a distributed ledger; and
linking the cryptographically unique token to the unique identifier of the at least one event item.

9. The method of claim 8, wherein the cryptographically unique token is generated based on at least one of:
the unique identifier of the at least one event item; or
information in the record of the at least one event item.

10. The method of claim 8, further comprising:
receiving an indication of payment from a purchaser of the at least one event item; and
transferring ownership of the cryptographically unique token to the purchaser of the at least one event item.

11. The method of claim 1, further comprising:
generating a plurality of duplicate tokens corresponding to the at least one item;
inserting information associated with the duplicate tokens onto a distributed ledger; and
linking the plurality of tokens to the unique identifier of the at least one event item.

12. The method of claim 11, further comprising:
receiving an indication of payment from a purchaser of a duplicate token in the plurality of duplicate token; and
transferring ownership of the duplicate token to the purchaser of the duplicate token.

13. The method of claim 12, further comprising:
generating a three-dimensional model of the at least one event item;
receiving a request from a user to access the three-dimensional model of the at least one event item in an augmented reality application;
determining whether the user is an owner of the token or a duplicate token in the plurality of duplicate tokens; and
granting the request to access the three-dimensional model of the at least one event item based at least in part on a determination that the user is an owner of the token or a duplicate token in the plurality of duplicate tokens.

14. The method of claim 1, further comprising:
generating a three-dimensional model of the at least one event item;
receiving a request from a user to access the three-dimensional model of the at least one event item;
granting the request to access the three-dimensional model of the at least one event item.

15. The method of claim 14, wherein granting the request to access the three-dimensional model of the at least one event item comprises one of:
rendering the three-dimensional model of the at least one event item in an application hosted on at least one of the one or more computing devices; or
transmitting the three-dimensional model of the at least one event item to an application on a device of the user.

16. The method of claim 15, wherein the application comprises an augmented reality application.

17. The method of claim 1, further comprising:
receiving the unique identifier of the at least one event item from a user device; and
transmitting at least a portion of the record of the at least one event item to the user device.

18. A computer system comprising:
at least one storage device storing instructions;
at least one processor configured to execute the instructions to perform the steps of:
storing a plurality of unique identifiers corresponding to a plurality of game items, each unique identifier corresponding to a unique game item in the plurality of game items;
generating a record for each of the plurality of unique identifiers;
determining a game event and the involvement of at least one event item, wherein the at least event item is a game item of the plurality of game items;
receiving a message indicating the game event, the message comprising the unique identifier of the at least one event item;
identifying the at least one event item based at least in part on the unique identifier of the event item;
updating the record of the at least one event item to indicate that the event item is the game item involved in the game event.
